(19) United States
(12) Patent Application Publication
(10) Pub. No.: US 2017/0060072 A1
(43) Pub. Date: Mar. 2, 2017

(54) IMAGE FORMING APPARATUS

(71) Applicant: CANON KABUSHIKI KAISHA, Tokyo (JP)

(72) Inventor: Shingo Hirota, Toride-shi (JP)

(21) Appl. No.: 15/248,899

(22) Filed: Aug. 26, 2016

(30) Foreign Application Priority Data
Aug. 31, 2015 (JP) 2015-171088

(51) Int. Cl. G03G 15/00

(52) U.S. Cl. CPC G03G 21/00; G03G 15/50

(57) ABSTRACT

After an image formation operation, an ending operation, by which an interposed toner layer is formed on a photosensitive drum and the photosensitive drum is stopped in a state where the interposed toner layer is interposed between the photosensitive drum and an intermediate transfer belt, is executed. In a case where a signal for starting the image formation operation is input after the photosensitive drum is stopped without executing the ending operation, a control circuit is able to execute, before executing the image formation operation, a recovery operation by which predetermined toner in a band shape is formed on the photosensitive drum, the predetermined toner is supplied to a contact part of the photosensitive drum and a blade, and the photosensitive drum is caused to rotate for a predetermined time or more.

### BACKGROUND OF THE INVENTION

Field of the Invention

The present invention relates to an image forming apparatus of an electrophotographic type or an electrostatic recording type.

Description of the Related Art

As an image forming apparatus such as a copier, a printer, or a multifunction device, an image forming apparatus including a photosensitive drum which carries a toner image and rotates (image carrier) and an intermediate transfer belt which forms a transfer portion, in which transfer of the toner image is performed, with the photosensitive drum therebetween (transfer rotating member) has been known conventionally. In such a configuration, when the photosensitive drum and the intermediate transfer belt stop rotating and are left for a long time in a state of abutting on each other, components contained in the intermediate transfer belt, such as a fluorine compound or a rubber material, transfer to the photosensitive drum in some cases. When such transfer of components occurs, there is a possibility that chargeability of the photosensitive drum changes locally, and a defective image such as an image including a halftone horizontal line (line-like image) is generated at a next image forming time. Then, a technique by which, when image forming is finished, toner is interposed between a photosensitive belt (image carrier) and an intermediate transfer belt is proposed (refer to Japanese Patent Laid-Open No. 2006-72007).

In a case where abnormality such as a jam of a recording material occurs, an image forming apparatus urgently stops an image forming operation (image formation operation) in some cases. In this case, a normal operation when the image formation operation ends (ending operation) is not executed, and the photosensitive drum and the intermediate transfer belt stop in a state where a sufficient amount of toner (toner layer) is not interposed between the photosensitive drum and the intermediate transfer belt. When the photosensitive drum and the intermediate transfer belt are left in such a state, there is a possibility that components of the intermediate transfer belt transfers to the photosensitive drum, and a defective image is generated at a next image forming time.

Then, embodiments of the invention provide an image forming apparatus capable of suppressing generation of a defective image even when an image formation operation is executed after an image carrier is stopped in a state where a sufficient toner layer is not interposed between an image carrier and a transfer rotating member.

### SUMMARY OF THE INVENTION

An image forming apparatus according to one aspect of the invention is an image forming apparatus, including: an image carrier configured to carry an image; a charging device configured to charge a surface of the image carrier; a developing device configured to develop, with toner, a latent image formed on the image carrier; a blade which abuts on the image carrier and configured to clean residual toner on the image carrier; an intermediate transfer member onto which a toner image formed on the image carrier is transferred at a transfer position in contact with the image carrier; and a control portion configured to execute a mode in which, after an image forming operation ends, toner for interposition is formed on the image carrier and a region of the image carrier, in which the toner for interposition is formed, is stopped at the transfer position, in which the control portion forms the toner for interposition under an image forming condition different from a condition at a time of image forming for forming an image on a recording material, and in which, in a case where the apparatus is stopped urgently during the image forming operation, the control portion executes a returning mode in which, before executing an image forming job to be performed after emergency stop, a predetermined toner band is formed on the image carrier, the predetermined toner band is supplied to a contact position of the image carrier and the blade, and the image carrier is driven after the predetermined toner band is supplied to the contact position.

Further features of the present invention will become apparent from the following description of exemplary embodiments with reference to the attached drawings.

### BRIEF DESCRIPTION OF THE DRAWINGS

FIG. 1 is a schematic configuration view illustrating an image forming apparatus according to a first exemplary embodiment.

FIG. 2 is a schematic configuration view illustrating an image forming portion of the image forming apparatus.

FIG. 3 is a schematic view illustrating a layer structure of an intermediate transfer belt.

FIG. 4 is a control block diagram of the image forming apparatus.

FIG. 5 is a flowchart illustrating a control process according to the first exemplary embodiment.

FIG. 6 is a flowchart illustrating a control process according to a second exemplary embodiment.

### DESCRIPTION OF THE EMBODIMENTS

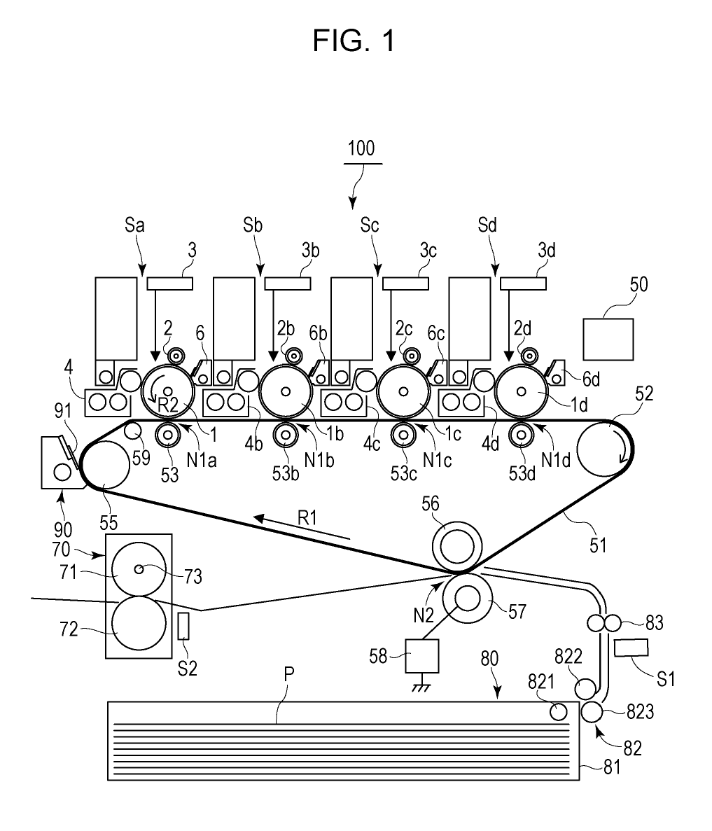

Hereinafter, description will be given for an image forming apparatus according to exemplary embodiments of the invention based on diagrams. Note that, in the description below, up-and-down and right-and-left directions are expressed based on a viewpoint from which the image forming apparatus is viewed from a front face thereof (viewpoint of FIG. 1).

### First Exemplary Embodiment

### Image Forming Apparatus

An image forming apparatus 100 according to a first exemplary embodiment is a full color electrophotography image forming apparatus using an intermediate transfer system, a schematic configuration of which is illustrated in FIG. 1. The image forming apparatus 100 includes, as image forming units each configured to form a toner image, four image forming portions (process units) Sa, Sb, Sc, and Sd which correspond to toner colors of yellow, magenta, cyan, and black, respectively.

An intermediate transfer belt 51 serving as a transfer rotating member is arranged below the image forming portions Sa, Sb, Sc, and Sd. The intermediate transfer belt 51 is an endless belt member, which is wound around a driving roller 52, a driven roller 55, a secondary inner transfer roller 56, a guide roller 59, and the like, and rotates in a rotating direction indicated with an arrow R1. The driving roller 52 is connected to a drive motor which is not illustrated, and causes the intermediate transfer belt 51 to rotate at a predetermined rotating speed (for example, 250 mm/s).

On an inner peripheral side of the intermediate transfer belt 51, primary transfer rollers 53, 53b, 53c, and 53d which face the photosensitive drums 1, 1b, 1c, and 1d, which are provided in the image forming portions Sa to Sd, respectively, with the intermediate transfer belt 51 therebetween are arranged. As nip parts between the intermediate transfer belt 51 and the photosensitive drums 1a to 1d, the primary transfer rollers 53, 53b, 53c, and 53d form primary transfer portions N1a, N1b, N1c, and N1d in which transfer of the toner images carried by the photosensitive drums 1a to 1d is performed. The toner images formed by the image forming portions Sa to Sd are aligned in the primary transfer portions N1a to N1d so as to overlap with each other and transferred (subjected to multiple transfer) onto the intermediate transfer belt 51, and a full color toner image is formed on the intermediate transfer belt 51.

The secondary inner transfer roller 56 is arranged so as to hold the intermediate transfer belt 51 with a secondary outer transfer roller 57 which is in contact with an outer peripheral surface of the intermediate transfer belt 51 therebetween, and forms a secondary transfer portion N2 as a nip part between the secondary outer transfer roller 57 and the intermediate transfer belt 51. The secondary outer transfer roller 57 is connected to a secondary transfer bias power source 58 provided in a high voltage output circuit board of an apparatus main body or the like, and applied with a secondary transfer bias voltage, and the toner image carried by the intermediate transfer belt 51 is transferred onto a recording material P in the secondary transfer portion N2.

Additionally, the image forming apparatus 100 has a feeding device 80, a pair of registration rollers 83, a fixing device 70, and the like. The feeding device 80 includes a sheet cassette 81 in which the recording material P such as a printing sheet or an OHP film is stacked, and a feeding unit 82 having a pickup roller 821, a feeding roller 822, and a retard roller 823. The recording material P stacked in the sheet cassette 81 is let out by the pickup roller 821, and then conveyed toward the pair of registration rollers 83 by the feeding roller 822. A driving force in a direction opposite to a conveyance direction of the recording material P is input to the retard roller 823, and pushes back recording materials P, which reach a nip part between the retard roller 823 and the feeding roller 822, to the sheet cassette 81 with one sheet at the top left.

The pair of registration rollers 83 corrects skew feeding of the recording material P when a leading edge of the recording material P butts thereagainst, and conveys the recording material P toward the secondary transfer portion N2 in accordance with a timing at which the toner image is transferred in the secondary transfer portion N2. The fixing device 70 includes a fixing roller 71, a pressure roller 72 which is in pressure contact with the fixing roller 71, a heater 73 which heats the fixing roller 71, and the like. The heater 73 is, for example, a halogen lamp which is disposed inside the fixing roller 71, and maintains a surface of the fixing roller 71 at a predetermined temperature when a voltage appropriately adjusted is supplied. When the pressure and the heat are applied to the recording material P, the fixing roller 71 and the pressure roller 72 cause toner particles to melt and adhere, and fix an image onto the recording material P. The recording material P onto which the image is fixed is discharged to a discharging tray, which is exposed outside the apparatus main body, via a discharging device provided in a downstream side of the fixing device 70.

Note that, in the image forming apparatus 100, conveyance position sensors S1 and S2 each serving as a detecting unit configured to be able to detect presence or absence of the recording material P at a predetermined position on a conveyance path of the recording material P from the sheet cassette 81 to the discharging tray are arranged. In an embodiment illustrated in FIG. 1, the conveyance position sensors S1 and S2 are arranged at an upstream position of the pair of registration rollers 83 (preregistration sensor) and at an upstream position of the fixing device 70 (pre-fixation sensor), respectively. Without limitation to the illustrated arrangement, the number of conveyance position sensors to be installed and positions at which the conveyance position sensors are installed may be changed according to, for example, a size of the recording material P on which an image is formed.

### [Image Forming Portion]

Next, by taking the image forming portion Sa of yellow as an example, each configuration of the image forming portions Sa to Sd will be described. Note that, the image forming portions Sb, Sc, and Sd of cyan, magenta, and black are configured similarly to the image forming portion Sa of yellow, except difference of toner colors. Therefore, for a component having a configuration and an action similar to those of the image forming portion Sa, “b”, “c”, or “d” is assigned to an end of a reference sign thereof, and description thereof will be omitted. Note that, in the present exemplary embodiment, the four image forming portions Sa to Sd are arranged in order of yellow, cyan, magenta, and black along the rotating direction of the intermediate transfer belt 51 (direction of the arrow R1), but the arrangement may be changed, and the number and combination of colors are not limited thereto, either.

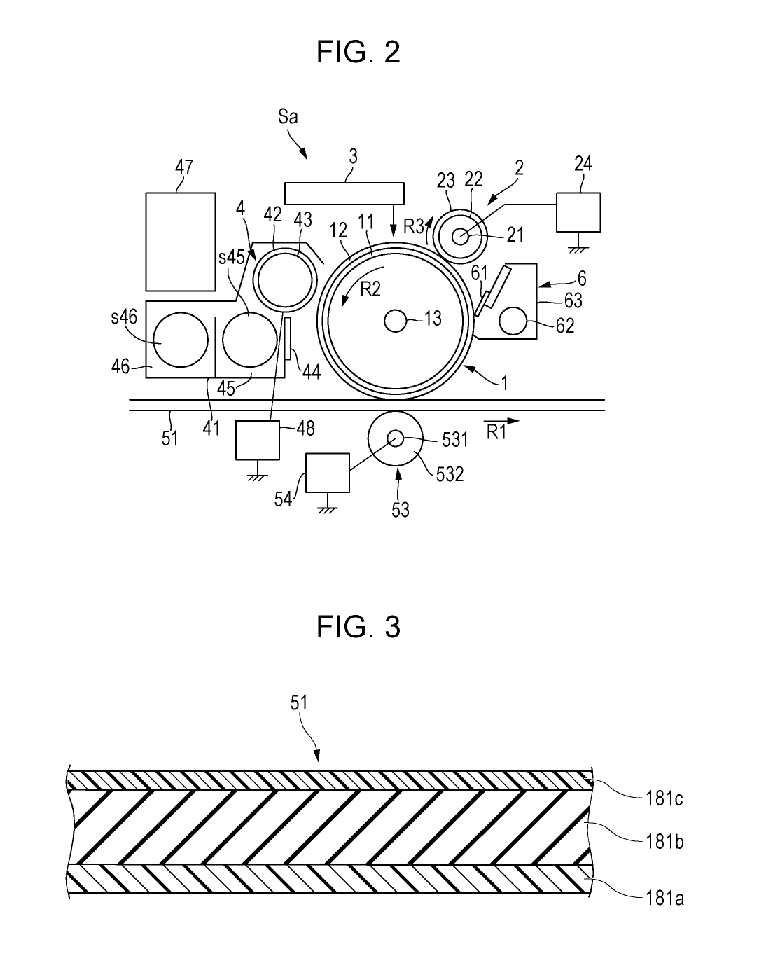

As illustrated in FIG. 2, the image forming portion Sa includes the photosensitive drum 1, a charging roller 2, a laser scanner 3, a developing device 4, a drum cleaner 6, and the like. The photosensitive drum 1 serving as an image carrier which carries a toner image is able to rotate in a direction along the rotating direction of the intermediate transfer belt 51 (direction of an arrow R2). The charging roller 2, the laser scanner 3, the developing device 4, the primary transfer roller 53, and the drum cleaner 6 are arranged in this order along a rotating direction of the photosensitive drum 1 around the photosensitive drum 1.

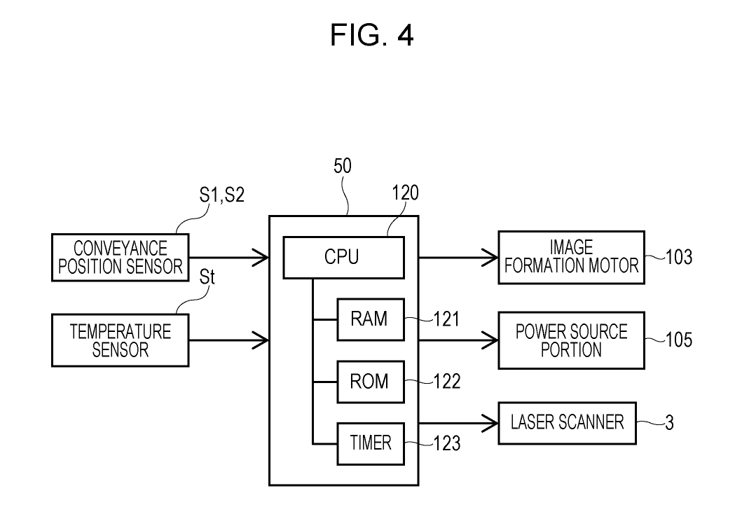

the photosensitive drum 1 is a cylindrical electrophotographic photosensitive member having, as a basic configuration thereof, an electro conductive base member 11 made of aluminum or the like and a photosensitive layer 12 formed on an outer periphery of the electro conductive base member 11. The photosensitive drum 1 is rotationally driven around a supporting axis 13, which is drive-coupled to a driving source (an image formation motor 103 of FIG. 4), at a peripheral speed (250 mm/s) in accordance with a rotating speed of the intermediate transfer belt 51. In the present exemplary embodiment, charging polarity of the photosensitive drum 1 is negative polarity, and a diameter of the photosensitive drum 1 is 30 mm.

The charging roller 2 arranged above the photosensitive drum 1 is a roller member having an electro conductive core metal 21 which is inserted into the center, a middle resistance electro conductive layer 23 which is formed on an outer peripheral part, and a low resistance electro conductive layer 22 which is formed between the core metal 21 and the middle resistance electro conductive layer 23. The charging roller 2 is arranged so as to be parallel to the photosensitive drum 1, and is supported by a bearing members (not illustrated) at both ends of the core metal 21 so as to be able to rotate freely. The bearing members are urged toward the photosensitive drum 1 by a pressing unit (not illustrated), and the charging roller 2 is made in pressure contact with a surface of the photosensitive drum 1 with a predetermined pressing force. Accordingly, the charging roller 2 is driven to rotate in a direction indicated with an arrow R3 according to rotation of the photosensitive drum 1.

The core metal 21 of the charging roller 2 is electrically connected to a charging bias power source 24, which is provided in the apparatus main body, is applied with a predetermined charging bias voltage, and uniformly charges the surface of the photosensitive drum 1 so as to have predetermined polarity and potential. For the charging bias voltage, one obtained by superposing an AC voltage whose amplitude is twice or more of that of a discharge starting voltage under an environment at that time on a DC voltage of −500 V is used, for example. In this case, the surface of the photosensitive drum 1 is uniformly charged so as to have potential of about −500 V by contact charging. Note that, a DC voltage applied during image forming is not limited to this value, and appropriately set to have potential, which is suitable for forming a good image, according to an environment (temperature, humidity, and the like), cumulative usage conditions of the photosensitive drum 1 and the charging roller 2, and the like.

The laser scanner 3 scans the surface of the photosensitive drum 1 while turning off/on laser beam based on image information, and exposes the photosensitive layer 12 of the photosensitive drum 1. Thereby, charge on the surface, which is applied by the charging roller 2, is eliminated, and an electrostatic image (latent image) in accordance with the image information is formed on the surface of the photosensitive drum 1.

The developing device 4 serving as a developing unit configured to supply toner to the photosensitive drum 1 includes a developing container 41, a developing sleeve 42, and a magnet roller 43. The developing container 41, inside of which is divided into a developing chamber 45 and an agitation chamber 46 with a partition wall, contains two-component developer containing non-magnetic toner particles (toner) and magnetic carrier particles (carrier) as developer. Screws s45 and s46, which agitate the developer while circularly conveying the developer between the developing chamber 45 and the agitation chamber 46, are provided in the developing chamber 45 and the agitation chamber 46, respectively. The toner and the carrier of the two-component developer are agitated by the screws s45 and s46 and thereby rubbed by each other, and then frictionally charged so as to have predetermined charging polarity (in the embodiment, the toner has negative polarity and the carrier has positive polarity).

Components of the two-component developer will be described here. For example, particles which are obtained by kneading a resin binder, which is mainly made of polyester, with pigment and performing pulverizing and sorting thereto and whose average particle diameter is about 6 μm are used for the toner. In addition, for example, one that is obtained by coating magnetic particles such as iron with resin, or one that is obtained by kneading a resin binder with a magnetic material and molding it into a particle shape is used for the carrier. In addition to them, in order to improve fluidity and improve functionality of adjusting chargeability of the toner and the carrier and the like, an external additive is added to the two-component developer. As such an external additive, silica, titanium dioxide, iron oxide, or the like is used.

The developing sleeve 42 is arranged in an opening part in which the developing container 41 opens toward the photosensitive drum 1, and forms a development region, in which the toner is delivered from the developing sleeve 42 to the photosensitive drum 1, between the developing sleeve 42 and the photosensitive drum 1. The developing sleeve 42 is a cylindrical member which is loosely fitted to an outer side of the magnet roller 43 having a plurality of magnetic poles in a circumferential direction, and is connected to the image formation motor 103 (refer to FIG. 4) and rotationally driven so as to circulate in an inner side and an outer side of the developing container 41. In the opening part of the developing container 41, a regulating blade 44 which regulates a height of the developer, which is absorbed to a surface of the developing sleeve 42 with a magnetic field of the magnet roller 43, for thinning.

The developing sleeve 42 is connected to a developing bias power source 48, and applied with a developing bias voltage obtained by superposing an AC voltage to a DC voltage which has the same polarity as the charging polarity of the toner. Thereby, the toner carried by the developing sleeve 42 moves to a side of the photosensitive drum 1 in the development region, and the electrostatic image on the photosensitive drum 1 is visualized (developed) as a toner image. In the embodiment of the present exemplary embodiment, setting is performed so that an average charge amount of the toner adhering to the photosensitive drum 1 is about −30 μC/g. In addition, for an AC component of the developing bias voltage, a square wave (AC bias) having a frequency of 10 KHz and amplitude of 1000 V is used.

The primary transfer roller 53 is a roller member constituted by a core metal 531 and an electro conductive layer 532 formed in a cylindrical shape in an outer peripheral side of the core metal 531, and is urged by a pressing member (not illustrated) such as a spring, which is connected to both ends thereof, toward the photosensitive drum 1. Thereby, the primary transfer roller 53 is made in pressure contact with the photosensitive drum 1 with a predetermined pressing force with the intermediate transfer belt 51 held therebetween, and is driven to rotate in accordance with rotation of the intermediate transfer belt 51 in a state of being in contact with an inner peripheral surface of the intermediate transfer belt 51.

To the core metal 531, a primary transfer bias power source 54 (power source) is connected, and a primary transfer bias voltage having polarity opposite to the charging polarity of the toner is applied. In the embodiment, the toner has negative charging polarity, and the primary transfer bias voltage has positive polarity. Thereby, a bias electric field which causes the charged toner particles to move toward the primary transfer roller 53 is formed in the primary transfer portion N1a, and the toner image carried by the photosensitive drum 1 is transferred (subjected to primary transfer) onto the surface of the intermediate transfer belt 51.

The drum cleaner 6 serving as a cleaning unit configured to clean the surface of the photosensitive drum 1 has a cleaning blade 61, a conveyance screw 62, and a cleaner housing 63, as illustrated in FIG. 2. The cleaning blade 61 is a blade member formed of a material such as urethane resin, and in pressure contact with the surface of the photosensitive drum 1 at a predetermined angle with a predetermined pressure. In the embodiment of the present exemplary embodiment, one obtained by molding urethane rubber, hardness of which is about 75 degree, so as to have a thickness of about 2.0 mm, a free length of about 8.0 mm, and a width in a main scanning direction (axial direction of the photosensitive drum 1) of about 320 mm is used. In this case, it is preferable that a leading edge of the cleaning blade 61 abuts on the photosensitive drum 1 at an angle (abutting angle) of 25° with respect to a circumferential direction thereof, and is pressed with a force of about 1300 gf in total toward radially inside. An adhering substance scraped from the photosensitive drum 1 by the cleaning blade 61 is collected inside the cleaner housing 63. The adhering substance collected in the cleaner housing 63 is conveyed by the conveyance screw 62 and discharged into a waste toner container (not illustrated) provided in the apparatus main body.

### [Intermediate Transfer Belt]

Next, the intermediate transfer belt 51 which is an endless elastic belt will be described by using FIG. 3. As illustrated in FIG. 3, the intermediate transfer belt 51 has a three layer structure constituted by a resin layer 181a which is a layer in the inner peripheral side, a surface layer 181c which is a layer in an outer peripheral side, and an elastic layer 181b which is formed between the resin layer 181a and the surface layer 181c. The resin layer 181a is formed of a resin material such as polycarbonate or fluorine-based resin (for example, ETFE (ethylene-tetrafluoroethylene copolymer) or PVDF (polyvinylidine fluoride)). The elastic layer 181b is formed of an elastomer material (elastic material) such as butyl rubber or fluorine-based rubber, and gives appropriate elasticity to the intermediate transfer belt 51.

In the embodiment of the present exemplary embodiment, the resin layer 181a is configured with polyimide (PI) whose surface resistivity is 10¹²Ω/□ and whose thickness is 100 μm. Here, a value of the surface resistivity is a value measured by using a probe conforming to JIS-K6911 under conditions of an applied voltage of 100 V, an application time of 60 sec, and 23° C./50% RH. Moreover, in order to adjust electro conductivity (resistance value) of the intermediate transfer belt 51, a conductive agent such as carbon black or graphite is added to the resin layer 181a and the elastic layer 181b.

The surface layer 181c of the intermediate transfer belt 51 can be able to stably convey toner when temporarily carrying the toner image transferred from the photosensitive drum 1, and can have a property which allows the toner to be separated easily (releasability) in the secondary transfer portion N2. The surface layer 181c in the present exemplary embodiment is formed of a resin material such as polyurethane or polyester, and an additive such as, for example, a fluorine compound is added and uniformly dispersed thereto in order to improve the releasability of the toner. The resin material configuring the surface layer 181c is not limited to the above-described materials, and a different material (a resin material or a rubber material) may be used therefor. Moreover, the additive is not limited to the fluorine compound, and elasticity of the surface layer 181c may be improved by adding a rubber material such as butyl rubber (high polymer rubber). Note that, the structure of the intermediate transfer belt 51 is not limited to the three layer structure, and may be a single layer structure, for example.

### [Operations of Image Forming Portion]

Next, operations of the image forming portion Sa will be described. Note that, description of the image forming portions Sb, Sc, and Sd other than that of yellow is also similar to the description below, so that the description thereof will be omitted. The apparatus main body of the image forming apparatus 100 is provided with a control circuit 50 serving as a control unit configured to control an operation of the image forming portion Sa (refer to FIG. 1). The control circuit 50 includes a CPU (central processing unit) 120, a RAM 121, a ROM 122, a timer 123, and the like, and reads a program or a setting value, each of which is stored in the ROM 121, on the RAM 122 to thereby execute a control process of controlling each device. In addition, the control circuit 50 is able to refer to current time by using the timer 123.

The control circuit 50 is connected to the above-described conveyance position sensors S1 and S2, and is able to detect presence or absence of abnormality of conveyance of the recording material P (jam, or the like) from a result of detection by the conveyance position sensors S1 and S2. In addition, the control circuit 50 is connected to a temperature sensor St which is provided in the apparatus main body and serves as a temperature detecting unit, and is able to detect a temperature of an inside of a housing of the image forming apparatus. The control circuit 50 transmits an output signal to the image formation motor 103, a power source portion 105, the laser scanner 3, and the like to control the image forming portions Sa to Sd. The power source portion 105 provided in the apparatus main body includes the secondary transfer bias power source 58, the primary transfer bias power source 54, the charging bias power source 24, and the developing bias power source 48, which are described above.

The image forming portion Sa according to the present exemplary embodiment is able to execute an adjusting operation before image forming, an image formation operation by which a toner image to be transferred onto the recording material P is formed on the photosensitive drum 1, and an ending operation (post rotation operation) which is performed when the image formation operation is ended. In a case where a signal for causing the image forming apparatus 100 to output an image (image forming job) is input, the image forming portion Sa performs the adjusting operation as necessary and then performs the image formation operation, and, when confirming that toner images of the same number as the number of necessary images have been formed, performs the post rotation operation to end the image forming job. However, in a case where there is less necessity of adjusting a condition of forming a toner image for the image formation operation, including a case where an interval from the last image forming job is short, it is possible to start the image formation operation without performing the adjusting operation.

As the adjusting operation, the control circuit 50 adjusts the condition of forming a toner image for the image formation operation by adjusting output values of the primary transfer bias voltage, the charging bias voltage, and the like while causing the photosensitive drum 1 to rotate. To describe specifically, the control circuit 50 measures a current amount which flows from the photosensitive drum 1 to the primary transfer roller 53 via the intermediate transfer belt 51 (transfer current), while applying an appropriate test voltage to the primary transfer roller 53. Then, the control circuit 50 adjusts the output value of the primary transfer bias voltage for the image formation operation so that the transfer current approximates a target value which is appropriately set by taking transfer efficiency in the primary transfer portion N1a into consideration. In addition, the control circuit 50 measures surface potential of the photosensitive drum 1 while applying an appropriate test voltage, which is obtained by superposing a DC voltage and an AC voltage, to the charging roller 2. Then, the control circuit 50 adjusts amplitude of an AC component of the charging bias voltage so that the surface of the photosensitive drum 1 is uniformly charged in the image formation operation.

When the adjusting operation ends, the control circuit 50 starts the image formation operation by which a toner image is formed on the photosensitive drum 1. That is, the control circuit 50 uniformly charges the surface of the photosensitive drum 1 by the charging roller 2 while causing the photosensitive drum 1 to rotate, and thereafter forms an electrostatic latent image on the photosensitive drum 1 by the laser scanner 3. At the same time, the control circuit 50 drives the developing device 4 to supply toner to the photosensitive drum 1, and develops the electrostatic latent image to form a toner image on the surface of the photosensitive drum 1. Further, the control circuit 50 applies the primary transfer bias voltage to the primary transfer roller 53 for causing the toner image carried by the photosensitive drum 1 to be subjected to primary transfer onto the intermediate transfer belt 51. Such an image formation operation is executed repeatedly until the necessary number of toner images are formed in accordance with the number of recording materials P subjected to continuous paper passing.

### [Ending Operation]

Next, the ending operation which is executed after the image formation operation and an interposed toner layer (toner for interposition) which is formed on the photosensitive drum 1 in the ending operation will be described. When detecting that the primary transfer of the toner image to be transferred onto the recording material P (the last recording material P in the case of continuous paper passing) has been finished, the control circuit 50 starts the ending operation.

When executing the ending operation, the control circuit 50 causes the photosensitive drum 1 to rotate and applies a predetermined interposing bias voltage to the charging roller 2 and the developing sleeve 42, and stops applying a voltage to the primary transfer roller 53. In the embodiment, as the interposing bias voltage, a voltage obtained by superposing an AC voltage, which is similar to that of the image formation operation, on a DC voltage set to be +500 V is applied to the charging roller 2, and a voltage obtained by superposing the AC voltage, which is similar to that of the image formation operation, on a DC voltage set to be −500 V is applied to the developing sleeve 42. Thereby, the surface of the photosensitive drum 1 is charged so as to have polarity opposite to charging polarity of the toner, so that, not by exposure with the laser scanner 3, the toner moves from the developing sleeve 42 to the photosensitive drum 1 and a uniform toner layer (interposed toner layer) is formed (analog development). Then, at a timing when a leading edge part of the interposed toner layer in the rotating direction of the photosensitive drum 1 reaches the primary transfer portion N1a, the control circuit 50 causes the photosensitive drum 1 to stop rotating. In other words, the control circuit 50 stops driving of the image formation motor 103 in a state where the interposed toner layer is interposed between the photosensitive drum 1 and the intermediate transfer belt 51 in the primary transfer portion N1a.

A condition of forming the toner for interposition will be described. At a time of image forming, a DC bias component which is applied to the charging roller 2 when a non-image region passes through the charging roller 2 is set to be a first charging DC bias. In addition, at the time of image forming, a DC bias component which is applied to the developing sleeve 42 when the non-image region passes through the developing sleeve 42 is set to be a first developing DC bias. Further, at a time of forming the toner for interposition, a DC bias component which is applied to the charging roller 2 when a region in which the toner for interposition is formed passes through the charging roller 2 is set to be a second charging DC bias. Furthermore, a DC bias component which is applied to the developing sleeve 42 when the region in which the toner for interposition is formed passes through the developing sleeve 42 is set to be a second developing DC bias. Note that, DC biases include zero. At this time, control is performed so that potential of the second charging DC bias with respect to the second developing DC bias (for example, set as −100 V) is in a side of polarity opposite to (plus side relative to) normal charging polarity of the toner (for example, set as negative polarity) with potential of the first charging DC bias with respect to the first developing DC bias (for example, −200 V) as a reference.

Moreover, the toner for interposition may be formed under a condition other than the above, as long as being formed so that an amount of the toner for interposition formed per unit area is larger than an amount of fogging toner per unit area, which adheres to the non-image forming region at the time of image forming.

Here, description will be given for a phenomenon which occurs in a case where rotation of the photosensitive drum 1 is stopped in a state where an amount of toner interposed between the photosensitive drum 1 and the intermediate transfer belt 51 is small. As described above, the surface layer 181c of the intermediate transfer belt 51 contains the additive of the fluorine compound or the like. When the image forming apparatus 100 is left in a state where the surface layer 181c of the intermediate transfer belt 51 is directly in contact with the photosensitive drum 1, or in a state where the amount of the toner interposed between the surface layer 181c and the photosensitive drum 1 is small, components of the additive or the like transfer to the photosensitive drum 1 gradually. When such components remain on the surface of the photosensitive drum 1, chargeability of the photosensitive drum 1 is changed locally. Then, when a next image forming job is input, a defective image such as an image including a halftone horizontal line corresponding to a part in which the components of the additive remain (line-like image) may be caused.

Note that, in the embodiment of the present exemplary embodiment, the fluorine compound is assumed to be the components which transfer to the photosensitive drum 1, but there is a case where different components of the intermediate transfer belt 51 transfer. For example, in a case where a rubber material (high polymer rubber) is used for a base or the additive of the surface layer 181c, it is considered that rubber molecules transfer to the photosensitive drum 1.

Then, the above-described interposed toner layer is formed as a toner layer having an amount of toner (amount on the drum) of not less than a predetermined amount which is set so as to be able to sufficiently protect the photosensitive drum 1 in a stop state. In the embodiment of the present exemplary embodiment, the amount of toner in the interposed toner layer is set to be 0.01 mg/cm², and the interposed toner layer is formed so as to have a length of 3 mm in the circumferential direction of the photosensitive drum 1 (sub scanning direction). With such an interposed toner layer, the components of the intermediate transfer belt 51 are prevented from transferring to the photosensitive drum 1 in the stop state of the photosensitive drum 1.

Note that, for a method of forming the interposed toner layer, a method of forming a uniform toner image by using the laser scanner 3 similarly to the image formation operation (digital development) may be used instead of the analog development. Moreover, in the case of a configuration in which the photosensitive drums 1, 1b, 1c, and 1d are able to be in contact with and separated from the intermediate transfer belt 51, and a part of the photosensitive drums 1, 1b, 1c, and 1d is stopped in a state of being separated from the intermediate transfer belt 51, the interposed toner layer may be formed only for the photosensitive drum abutting on the intermediate transfer belt 51.

### [Emergency Stop]

Next, emergency stop of the image forming apparatus 100 will be described. Normally, the image forming portion Sa performs an operation after the image formation operation, and stops rotation of the photosensitive drum 1 and the intermediate transfer belt 51 in a state where the interposed toner layer is interposed between the photosensitive drum 1 and the intermediate transfer belt 51. In addition, also in a case where the control circuit 50 detects some abnormality during the image formation operation, when the abnormality is relatively insignificant, the control circuit 50 discontinues an image forming job and executes the ending operation to stop the photosensitive drum 1 and the intermediate transfer belt 51. However, in a case where the abnormality detected by the control circuit 50 is one that can give serious damage to the apparatus, the control circuit 50 executes an emergency stop operation (forced stop operation), by which the photosensitive drum 1 and the intermediate transfer belt 51 are forcibly stopped (urgently stopped), without performing the ending operation.

An example of the case where such an emergency stop operation is executed includes a case where a jam of the recording material P (sheet jam) occurs. In a case where, when the jam occurs inside the image forming apparatus 100, conveyance of recording materials P is continued, there is a risk that the succeeding recording materials P come into collision with the recording material P blocking the conveyance path one after another, and breakage of a conveyance system may be caused. In addition to the jam, also in a case where occurrence of a serious obstacle is detected, for example, in a case where a user erroneously opens a housing cover during the image formation operation, or a case where a leakage of electricity, overheating of the fixing device, or the like occurs, the control circuit 50 executes the emergency stop operation. Note that, in addition to the case where the control circuit 50 executes the emergency stop operation, a case where the photosensitive drum 1 and the intermediate transfer belt 51 are forcibly stopped due to an external factor such as a power breakdown is also included in the emergency stop.

When executing the emergency stop operation, the control circuit 50 stops driving of the photosensitive drum 1 and the intermediate transfer belt 51, and transmits a control signal to the power source portion 105 to cause the power source portion 105 to stop applying the charging bias voltage, the developing bias voltage, and the like. Therefore, in a case where the image forming apparatus 100 is stopped urgently, a state where the photosensitive drum 1 and the intermediate transfer belt 51 are stopped with no interposed toner layer formed (emergency stop state) is provided. Note that, in a case where the image forming apparatus 100 is stopped urgently in the middle of the image formation operation, the photosensitive drum 1 and the intermediate transfer belt 51 are stopped in a state where a toner image to be transferred onto a recording material P exists in the primary transfer portion N1a, in some cases. However, an amount of toner of such a toner image is generally uneven, and a part in which only a smaller amount of (thinner) toner than that of the interposed toner layer exists between the photosensitive drum 1 and the intermediate transfer belt 51 is generated.

After the image forming apparatus 100 is stopped urgently, the control circuit 50 waits in the emergency stop state until it is confirmed that the obstacle (abnormality) which has caused the emergency stop is removed. When confirming that the obstacle is removed, the control circuit 50 returns to a state of being capable of receiving an image forming job. During this time period, the photosensitive drum 1 and the intermediate transfer belt 51 are left for a long time in the emergency stop state in some cases. For example, in a case where a service person having a specialized knowledge is required to cope with it, it is considered that the photosensitive drum 1 and the intermediate transfer belt 51 are left over several hours in the emergency stop state. As described above, when the photosensitive drum 1 and the intermediate transfer belt 51 are left in a state where an amount of toner interposed therebetween is insufficient, components of the intermediate transfer belt 51 transfer to the photosensitive drum 1. Then, for an image forming job which is input first after the image forming apparatus 100 returns from the emergency stop state, a defective image such as a line-like image can be generated. Note that, the components of the intermediate transfer belt 51, which have transferred to the photosensitive drum 1, are gradually removed by the drum cleaner 6 and the like while the image formation operation is repeated, but there is a possibility that defective images are continuously generated before a state of the photosensitive drum 1 is recovered.

### [Recovery Operation]

Then, the control circuit 50 according to the present exemplary embodiment is configured to be able to execute a recovery operation by which, in the case where the image forming apparatus 100 is stopped urgently, performance of the photosensitive drum 1 is recovered at a time of returning from the emergency stop state. When executing the recovery operation, the control circuit 50 supplies toner to the cleaning blade 61 of the drum cleaner 6, while causing the photosensitive drum 1 to rotate. Specifically, the control circuit 50 applies a developing bias voltage having polarity opposite to charging polarity of toner to the developing sleeve 42, and causes the toner to adhere to the photosensitive drum 1 (forms a toner band), and stops applying a primary transfer bias voltage to the primary transfer roller 53. Thereby, most of the toner supplied from the developing device 4 passes through the primary transfer portion N1a and reaches an abutting part of the cleaning blade 61 and the photosensitive drum 1. Note that, instead of a configuration in which application of a voltage to the charging roller 2 and exposure by the laser scanner 3 are stopped and toner is supplied, a configuration in which a necessary amount of toner is supplied by the digital development similarly to the image formation operation may be provided. Note that, the toner band is formed in a region corresponding to a maximum image forming region. That is, a length of a width of the toner band in a longitudinal direction is equal to or longer than that of a width corresponding to a width of the maximum image forming region.

When toner carried by the photosensitive drum 1 reaches the cleaning blade 61, while toner particles are scraped by the cleaning blade 61, a part of externally added particles (particles of the external additive) enters an interval in the abutting part of the cleaning blade 61 and the photosensitive drum 1. In accordance with the rotation of the photosensitive drum 1, the surface of the photosensitive drum 1 is rubbed with the external additive which functions as a polishing material, and thereby the transfer components which had transferred from the intermediate transfer belt 51 to the photosensitive drum 1 are removed.

### [Control Flow]

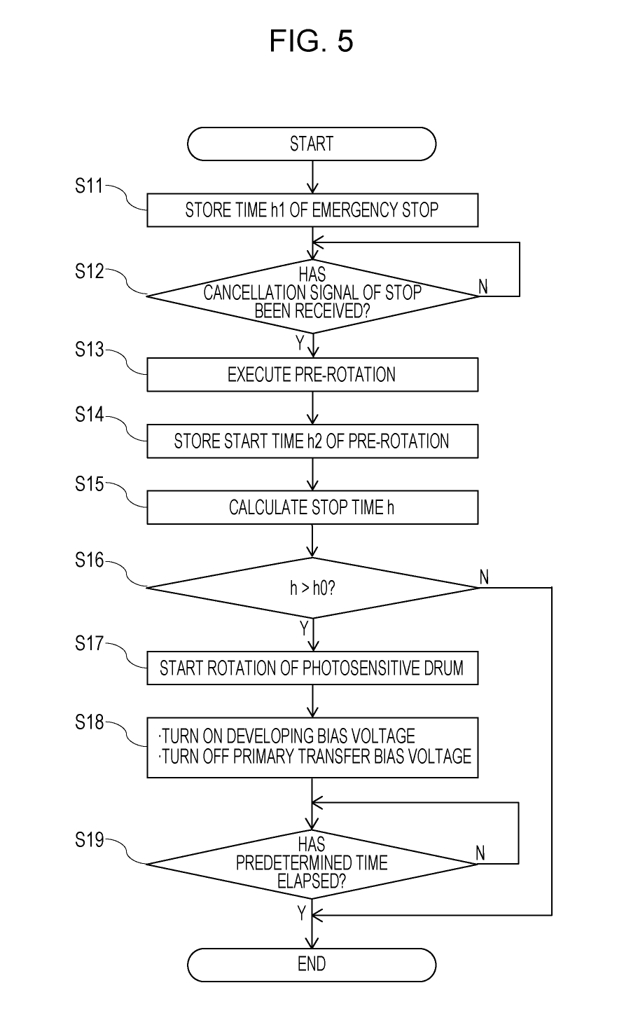

Hereinafter, a control process in a case where the image forming apparatus 100 according to the present exemplary embodiment is stopped urgently will be described along a flowchart illustrated in FIG. 5. When the image forming apparatus 100 is stopped urgently, the control circuit 50 stores time h1 at which the emergency stop occurred (S11). Specifically, in the above-described case where the emergency stop operation is executed, time at which the control circuit 50 sends a signal of emergency stop including a signal for stopping the photosensitive drum 1 and the intermediate transfer belt 51 is set as the time h1. Moreover, in the case where the image forming apparatus 100 is stopped urgently due to an external factor such as a power breakdown, time at which the control circuit 50 detects stopping of the photosensitive drum 1 or the intermediate transfer belt 51 is set as the time h1. Note that, in a case where power supply to an image forming apparatus is interrupted due to a power breakdown or the like, and the image forming apparatus does not include an auxiliary power source such as a storage battery, the control circuit 50 calculates and stores the time h1, at which the emergency stop occurred, by referring to the timer 123 when power supply is started again.

After the emergency stop, the control circuit 50 waits until a cancellation signal of stop with which the emergency stop state is canceled is detected (S12). Here, the cancellation signal of stop is a signal which notifies that an obstacle which caused the emergency stop is removed. Specifically, an input signal when a service person operates a liquid crystal panel provided in the apparatus main body to input completion of returning work, and a detection signal from a sensor connected to the control circuit 50 (for example, the conveyance position sensors S1 and S2 and the temperature sensor St) can be the cancellation signal of stop. Note that, in a case where a main power source of the image forming apparatus 100 is shut down during the waiting time, the control circuit 50 saves a value of the time h1 in a nonvolatile storage device, and then discontinues the control process.

When an image forming job is input after the detection of the cancellation signal of stop, the control circuit 50 sends a control signal, by which the adjusting operation is executed as necessary, to each device (S13), and stores time h2 at which the execution of the adjusting operation is started (S14). Then, as a difference between the time h1 and the time h2, the control circuit 50 calculates a stop time h which is a time length for which the image forming apparatus 100 is left (which has passed) in the emergency stop state (S15).

In a case where the stop time h is equal to or less than a predetermined threshold h0 (N at S16), the control circuit 50 executes the image formation operation similarly to a normal image forming job. Here, the predetermined threshold h0 is a value which is set as a minimum value of the stop time, during which a defective image such as a line-like image can be generated after returning, by taking a material of a photosensitive drum and an intermediate transfer belt, which are used for an image forming apparatus, and the like in consideration.

In a case where the stop time h is more than the threshold h0 (Y at S16), the control circuit 50 executes the recovery operation (S17 to S19). That is, the control circuit 50 causes the photosensitive drum 1 to start rotating (S17), and applies a developing bias voltage, while stopping applying a primary transfer bias voltage (S18). Thereby, the control circuit 50 causes the photosensitive drum 1 to continue the rotation, while supplying toner (toner band) to the cleaning blade 61. However, the photosensitive drum 1 may be caused to rotate continuously without temporally stopping between the adjusting operation and the recovery operation.

Then, the control circuit 50 causes the photosensitive drum 1 to continue the rotation for a predetermined time (S19), and thereafter stops the photosensitive drum 1 to thereby ends the recovery operation. Here, the predetermined time is a time required for sufficient removal of transfer components, and set by taking an amount of components contained in the intermediate transfer belt 51, which can be the transfer components, ease of transferring to the photosensitive drum 1, a polishing speed of the cleaning blade 61 in a state where externally added particles are supplied, and the like into consideration. In the embodiment of the present exemplary embodiment, a rotation operation of the photosensitive drum 1 as the recovery operation is continued over sixty seconds. When the recovery operation ends, the control circuit 50 moves to the image formation operation in accordance with a conveyance timing of a recording material P and an image formation timing of a different image forming portion.

### [Effect of Invention]

The control circuit 50 according to the present exemplary embodiment is configured to be able to execute the recovery operation, by which the performance of the photosensitive drum 1 is recovered, before starting a current image formation operation, in a case where the image forming apparatus 100 was stopped urgently in the last image forming job. Then, when the image forming apparatus 100 is left in the state where the interposed toner layer is not formed, it is possible to remove transfer components, which have transferred from the intermediate transfer belt 51 to the photosensitive drum 1, by the recovery operation. Moreover, at a time point of starting the image formation operation performed after the recovery operation, it is possible to bring the photosensitive drum 1 into a state suitable for image formation (state where there is no unevenness of chargeability). Therefore, even when the image forming apparatus 100 is stopped urgently, it is possible to improve stability of image quality by suppressing generation of a defective image, which is caused by transfer components, in an image forming job after returning.

Since the cleaning blade 61 always abuts on the photosensitive drum 1, in a case where the photosensitive drum 1 is caused to rotate in the adjusting operation, a part of components of the intermediate transfer belt 51, which has transferred to the photosensitive drum 1, is removed by the cleaning blade 61. However, a rotation amount of the photosensitive drum 1 in the adjusting operation is generally set to be a small value so that the process moves to the image formation operation immediately after adjustment of a condition of forming a toner image (the charging bias voltage, the primary transfer bias voltage, and the like) is completed. Moreover, since the primary transfer bias voltage is applied for adjustment of the primary transfer bias voltage, an amount of toner which reaches the cleaning blade 61 is extremely small. Thus, a cleaning effect (polishing effect) of the cleaning blade 61 in the adjusting operation is small, and it is difficult to sufficiently remove the transfer components in some cases.

On the other hand, when performing the recovery operation, the control circuit 50 according to the present exemplary embodiment applies the developing bias voltage and stops applying the primary transfer bias voltage. Thereby, toner is supplied from the developing sleeve 42 to the photosensitive drum 1, and most of the toner passes through the primary transfer portion N1a and reaches the abutting part of the cleaning blade 61 and the photosensitive drum 1. Since the externally added particles contained in the toner function as a polishing material, it is possible to improve cleaning performance of the cleaning blade 61 and efficiently remove the transfer components. Accordingly, it is possible to suppress an increase in a preparation period until the process moves to the image formation operation after an image forming job is input, which is caused due to addition of cleaning processing, and to improve stability of image quality without deteriorating productivity of the image forming apparatus 100.

### Other Exemplary Embodiments

In the present exemplary embodiment, when executing the recovery operation, the control circuit 50 stops applying the primary transfer bias voltage, but may be configured so as to apply a voltage having polarity opposite to charging polarity of toner. In this case as well, since most of the toner supplied to the photosensitive drum 1 reaches the cleaning blade 61, an effect similar to that of the present exemplary embodiment described above is able to be obtained.

Moreover, a timing of executing the recovery operation may be a timing before execution of the adjusting operation or a timing interrupting the adjusting operation. In short, the timing only needs to be a timing after the image forming apparatus 100 returns from the emergency stop state and before the image formation operation of the first image forming job after the returning is started.

### Second Exemplary Embodiment

Next, the image forming apparatus 100 according to a second exemplary embodiment will be described. This image forming apparatus 100 is different from that of the first exemplary embodiment described above in that the above-described cleaning processing is executed based on information indicating a state of the intermediate transfer belt 51 and environment information (temperature information) after emergency stop. Since other configurations are similar to those of the first exemplary embodiment, the same reference signs are assigned to components which are common to the first exemplary embodiment, and description thereof will be omitted.

### [Cumulative Number of Uses of Intermediate Transfer Belt]

Transfer components such as a fluorine compound, which are dispersed on the surface layer 181c of the intermediate transfer belt 51 gradually transfer to a member in contact with the outer peripheral surface of the intermediate transfer belt 51, such as the photosensitive drum 1 or the secondary outer transfer roller 57 and decreases. Accordingly, as the cumulative number of uses which is the number of times the intermediate transfer belt 51 is used for the image formation operation increases, ooze (transfer) of transfer components from the intermediate transfer belt 51 to the photosensitive drum 1 becomes less likely to be caused. On the other hand, from the intermediate transfer belt 51 whose cumulative number of uses is small (which is nearly new), the ooze to the photosensitive drum 1 is likely to be caused.

Then, the control circuit 50 according to the present exemplary embodiment is configured to be able to count the cumulative number of uses (ITB durability count C) of the intermediate transfer belt 51, and, based on the cumulative number of uses, judges whether or not to execute the recovery operation. Specifically, as the cumulative number of uses, the control circuit 50 uses image formation count (paper passing count) which is counted by using the conveyance position sensors S1 and S2 or the like and which is the number of times a recording material P passes through the secondary transfer portion N2. In a case where the image formation count is less than the reference number of times, the control process leading to the recovery operation is continued, and in a case where the image formation count is equal to or more than the reference number of times, it is judged that an oozing amount is sufficiently small, and the recovery operation is not executed.

### [Environment Information During Emergency Stop]

On the other hand, the oozing amount of components of the intermediate transfer belt 51 to the photosensitive drum 1 depends on an internal temperature of the image forming apparatus 100 in the emergency stop state. That is, there is a tendency that, as a temperature in a vicinity of the primary transfer portion N1a in the emergency stop state is high, a large amount of transfer components transfer to the photosensitive drum 1.

Then, the control circuit 50 according to the present exemplary embodiment uses the temperature sensor St provided in the apparatus main body (refer to FIG. 4) to thereby monitor the internal temperature of the image forming apparatus 100 in the emergency stop state and judges, based on a value of the internal temperature, whether or not to execute the recovery operation. That is, the control circuit 50 calculates an average value of the internal temperature in the emergency stop state (temperature T), which is measured by using the temperature sensor St, and refers to a table stored in the ROM 122 or the like, such as one indicated in Table. However, in a case where a power supply of the apparatus main body is shut down during emergency stop, the average value is estimated from a temperature before the power supply is shut down and a temperature after the power supply is started again. Then, according to a correlation indicated by the table, one of a plurality of numerical values which are set in advance is selected as the threshold h0 of the recovery operation. In an embodiment indicated in Table, a value of the threshold h0 is set to be one hour in a case where the temperature T is equal to or more than 28° C., and set to be four hours in a case where the temperature T is equal to or more than 22° C. and less than 28° C., and the recovery operation is not executed in a case where the temperature T is less than 22° C. (h0 is infinity).

TABLE

| Temperature T | Threshold h 0 |
|---|---|
| T ≧ 28° C. | One hour |
| 28° C. > T ≧ 22° C. | Four hours |
| 22° C. > T | ∞ (Not executed) |

### [Control Flow]

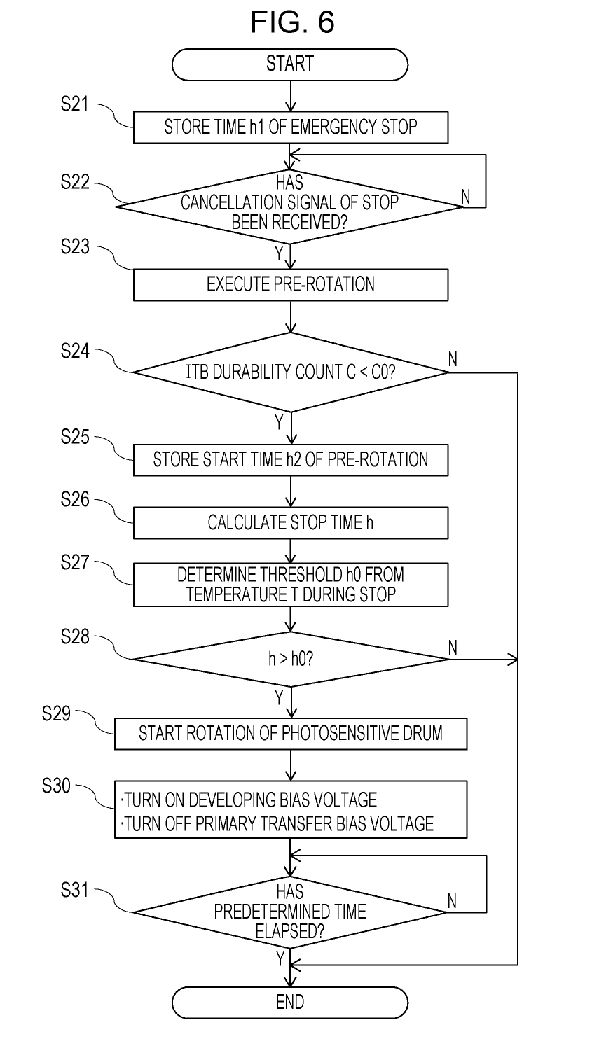

Hereinafter, a control process in a case where the image forming apparatus 100 according to the present exemplary embodiment is stopped urgently will be described along a flowchart illustrated in FIG. 6. When the image forming apparatus 100 is stopped urgently, the control circuit 50 stores time h1 at which the emergency stop occurred (S21), and waits until the cancellation signal of stop with which the emergency stop state is canceled is detected (S22).

When an image forming job is input after the detection of the cancellation signal of stop, the control circuit 50 sends the above-described control signal, by which the adjusting operation is executed, to each device (S23), and checks a value of the ITB durability count C (image formation count). In a case where the ITB durability count C is equal to or more than the reference number of times C0 (N at S24), the control circuit 50 moves to the image formation operation without executing the recovery operation. On the other hand, in a case where the ITB durability count C is less than the reference number of times (Y at S24), the control circuit 50 stores time h2 at which execution of the adjusting operation is started (S25). Thereafter, the control circuit 50 calculates a stop time h as a difference between the time h1 and the time h2.

Next, based on the temperature T during the emergency stop, which is measured by the temperature sensor St, the control circuit 50 determines the threshold h0 of the stop time for executing the recovery operation (S27). The control circuit 50 moves to the image formation operation in a case where the stop time h is equal to or less than the predetermined threshold h0 (N at S28), and executes the recovery operation (S29 to S31) after the adjusting operation is completed in a case where the stop time h is more than the threshold h0 (Y at S28). That is, the control circuit 50 causes the photosensitive drum 1 to start rotating (S29), and applies the developing bias voltage, while stopping applying the primary transfer bias voltage (S30). Then, the control circuit 50 causes the photosensitive drum 1 to continue the rotation for a predetermined time or more (for example, sixty seconds) (S31), and thereafter causes the photosensitive drum 1 to stop to thereby ends the recovery operation. When the recovery operation ends, the control circuit 50 moves to the image formation operation in accordance with a conveyance timing of a recording material P and an image formation timing of a different image forming portion.

### [Effect of Invention]

The control circuit 50 according to the present exemplary embodiment judges whether or not to execute the recovery operation, based on the cumulative number of uses of the intermediate transfer belt 51. Therefore, in a situation where the intermediate transfer belt 51 is nearly new and the ooze to the photosensitive drum 1 is likely to be caused, by performing the recovery operation as necessary, it is possible to prevent a defective image such as a line-like image from being generated. On the other hand, in a situation where, after the intermediate transfer belt 51 is used repeatedly, the ooze is less likely to be caused, the recovery operation is omitted and the process moves to the image formation operation immediately. Thereby, it is possible to suppress an increase in a time lag (down time) from an input of an image forming job to a start of the image formation operation, and improve stability of image quality by suppressing generation of a defective image.

Moreover, the control circuit 50 according to the present exemplary embodiment selects the threshold h0 of the stop time for executing the recovery operation, based on the temperature T of an inside of the apparatus in the emergency stop state. Thereby, under an environment in which the temperature T is high and the ooze to the photosensitive drum 1 is likely to be caused, by performing the recovery operation as necessary, it is possible to prevent a defective image such as a line-like image from being generated. On the other hand, under an environment in which the temperature T is low and the ooze is less likely to be caused, the recovery operation is omitted and the process moves to the image formation operation immediately. This makes it possible to perform the recovery operation only in a situation where necessity of cleaning is high, so that it is possible to further suppress the increase in the down time, and improve stability of image quality by suppressing generation of a defective image.

### Other Exemplary Embodiments

In the present exemplary embodiment, as long as whether or not to execute the recovery operation is judged according to a temporal change of the intermediate transfer belt 51, a configuration in which the control circuit 50 refers to an indicator other than the cumulative number of uses (ITB durability count C) may be adopted. For example, a total operating time (a time in which the main power source is ON) of the image forming apparatus 100 may be referred to, or the total number of rotations of a drive motor which drives the intermediate transfer belt 51 may be referred to. In these cases as well, an effect similar to that of the present exemplary embodiment is able to be exerted.

Note that, though the average temperature in the emergency stop state is used in the present exemplary embodiment, a configuration in which the threshold h0 is selected by using a temperature at a timing when adjustment processing is executed first after emergency stop, or a maximum value of a temperature in the emergency stop state may be adopted. Further, without limitation to the configuration in which the temperature information is referred to, a configuration in which the control circuit 50 refers to different environment information which has an influence on an oozing amount from the intermediate transfer belt 51 to the photosensitive drum 1 (for example, humidity in the inside of the apparatus) may be adopted.

Moreover, without limitation to the configuration in which whether or not to execute the recovery operation is judged by incorporating, into the control process, both of the condition according to the cumulative number of uses of the intermediate transfer belt 51 and the condition according to the internal temperature of the apparatus, a configuration in which the judgment is made by using any one of them may be adopted. Even in this case, an effect that the increase in the down time is suppressed as described above and generation of a defective image is suppressed is able to be obtained.

In the above-described first and second exemplary embodiments, the present technique has been applied to the image forming apparatus 100 of the intermediate transfer system, but is able to be applied to an image forming apparatus other than this. For example, the present technique may be applied to an image forming apparatus of a direct transfer system in which a photosensitive drum is made in contact with a recording material directly. In this case, by applying the present technique, it is possible to suppress generation of a defective image due to components which transfer to the photosensitive drum from a transfer rotating member such as a transfer roller or a transfer conveyance belt, which abuts on the photosensitive drum.

According to embodiments of the invention, it is possible to suppress generation of a defective image even when an image formation operation is executed after an image carrier is stopped in a state where a sufficient toner layer is not interposed between the image carrier and a transfer rotating member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-171088, filed on Aug. 31, 2015, which is hereby incorporated by reference herein in its entirety.

What is claimed is:

1. An image forming apparatus, comprising:
an image carrier configured to carry an image;
a charging device configured to charge a surface of the image carrier;
a developing device configured to develop, with toner, a latent image formed on the image carrier;
a blade which abuts on the image carrier and configured to clean residual toner on the image carrier;
an intermediate transfer member onto which a toner image formed on the image carrier is transferred at a transfer position in contact with the image carrier; and
a control portion configured to execute a mode in which, after an image forming operation ends, toner for interposition is formed on the image carrier and a region of the image carrier, in which the toner for interposition is formed, is stopped at the transfer position,
wherein, the control portion forms the toner for interposition under an image forming condition different from a condition at a time of image forming for forming an image on a recording material, and
wherein, in a case where the apparatus is stopped urgently during the image forming operation, the control portion executes a returning mode in which, before executing an image forming job to be performed after emergency stop, a predetermined toner band is formed on the image carrier, the predetermined toner band is supplied to a contact position of the image carrier and the blade, and the image carrier is driven after the predetermined toner band is supplied to the contact position.

2. The image forming apparatus according to claim 1, wherein in a case where, at a time of image forming, a DC bias which is applied to the charging device when a non-image region passes through the charging device is set to be a first charging DC bias, and a DC bias which is applied to the developing device when the non-image region passes through the developing device is set to be a first developing DC bias, and, at a time of forming the toner for interposition, a DC bias which is applied to the charging device when a region in which the toner for interposition is formed passes through the charging device is set to be a second charging DC bias, a DC bias which is applied to the developing device when the region in which the toner for interposition is formed passes through the developing device is set to be a second developing DC bias, the first charging DC bias with respect to the first developing DC bias is set to be first potential, and the second charging DC bias with respect to the second developing DC bias is set to be second potential, the control portion performs control so that the second potential is in a side of polarity opposite to normal charging polarity of the toner with the first potential as a reference.

3. The image forming apparatus according to claim 1, comprising a detecting portion which is able to detect presence or absence of a recording material in an inside of the apparatus,
wherein the control portion urgently stops the image forming operation based on a result of detection by the detecting portion.

4. The image forming apparatus according to claim 1, wherein the intermediate transfer member contains at least one of a fluorine compound and high polymer rubber.

5. The image forming apparatus according to claim 1,
wherein the control portion executes the returning mode according to an elapsed time until a next image forming job is executed after the emergency stop is performed.

6. The image forming apparatus according to claim 1,
wherein the control portion executes the returning mode according to an elapsed time until a next image forming job is executed after the emergency stop is performed, and information on a cumulative number of uses of the intermediate transfer member.

7. The image forming apparatus according to claim 1,
wherein the control portion executes the returning mode according to an elapsed time until a next image forming job is executed after the emergency stop is performed, and a result of detection by the environment detecting portion.

8. The image forming apparatus according to claim 1, wherein the control portion executes the returning mode according to the elapsed time until a next image forming job is executed after the emergency stop is performed, the result of detection by the environment detecting portion, and information on a cumulative number of uses of the intermediate transfer member.
